(19) United States
(12) Patent Application Publication
(10) Pub. No.: US 2016/0062625 A1
(43) Pub. Date: Mar. 3, 2016

(54) COMPUTING DEVICE AND METHOD FOR CLASSIFYING AND DISPLAYING ICONS

(71) Applicants: Fu Tai Hua Industry (Shenzhen) Co., Ltd., Shenzhen (CN); HON HAI PRECISION INDUSTRY CO., LTD., New Taipei (TW)

(72) Inventors: HAI-JUN MAO, Shenzhen (CN); CHIH-SAN CHIANG, New Taipei (TW); HAI-SEN LIANG, Shenzhen (CN)

(21) Appl. No.: 14/725,634

(22) Filed: May 29, 2015

(30) Foreign Application Priority Data
Sep. 3, 2014 (CN) 201410444863.8

(51) Int. Cl. G06F 3/0484; G06F 3/0482; G06K 9/20; G06F 3/0481

(52) U.S. Cl. CPC G06F 3/04847; G06F 3/04817; G06F 3/0482; G06K 9/2054

(57) ABSTRACT

In a method for classifying and displaying icons on a desktop, a main interface having icons of all the installed applications is generated. Each icon is associated with an application installed on an electronic device. Classes of the applications are obtained and a navigation interface having a number of class icons is generated. A request to search for applications belonging to a single class is recognized, and a sub-interface having all the icons of applications belonging to the searched class is generated.

### CROSS-REFERENCE TO RELATED APPLICATIONS

This application claims priority to Chinese Patent Application No. 201410444863.8 filed on Sep. 3, 2014, the contents of which are incorporated by reference herein.

### FIELD

The subject matter herein generally relates to desktop icons management.

### BACKGROUND

With the development of computing technology, more and more application programs are installed in computing devices. A multiplicity of icons displayed on a user's computer desktop is not conveniently ordered.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a hardware environment for executing a desktop icons classifying and displaying system.

FIG. 2 is a block diagram of one embodiment of function modules of the desktop icons classifying and displaying system in FIG. 1.

FIG. 3 is a diagrammatic view of an embodiment of a main interface.

FIG. 4 is a diagrammatic view of an embodiment of a navigation interface.

FIG. 5 is a diagrammatic view of an embodiment of a sub-interface for a desktop.

FIG. 6 is a flowchart of one embodiment of a method for classifying and displaying desktop icons.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like. The term “desktop”, as used hereinafter, means an on-screen work area that presents icons and menus to access files or applications. The term “icon”, as used hereinafter, means an image displayed on a computer desktop which runs an application when clicked. The term “page”, as used hereinafter, may be understood as one or more virtual frames of the content, or a virtual display window presenting content to the user. The term “class,” means one type of application programs, such as system software including operation system for example; entertainment software including media players and a browser for example; media development software including digital video maker for example; product engineering software including computer-aided design (CAD) and computer-aided engineering (CAE) for example; and the like.

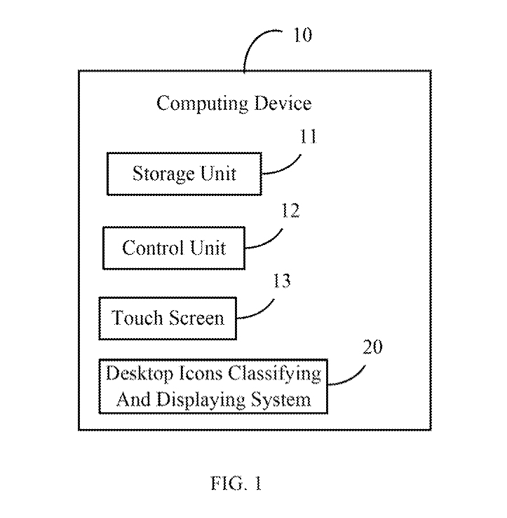

FIG. 1 is a block diagram of one embodiment of a hardware environment for executing a desktop icons classifying and displaying system. The desktop icons classifying and displaying system 20 (hereinafter “system 20”) is installed and run in an apparatus, for example a computing device 10. In at least one embodiment as shown in FIG. 1, the computing device 10 includes, but is not limited to, a storage unit 11, a control unit 12, and a touch screen 13. The computing device 10 can be a tablet computer, a notebook computer, a smart phone, a personal digital assistant (PDA), or other suitable electronic device. FIG. 1 illustrates only one example of the computing device; others can include more or fewer components than illustrated, or have a different configuration of the various components in other embodiments.

The system 20 can recognize classes of the applications and generate class icons. Each class icon represents a class of applications, and the system 20 can further generate a navigation interface which includes all class icons. A user of the computing device 10 can quickly search through applications belonging to a class via the class icon on the navigation interface.

In at least one embodiment, the storage unit 11 can include some type(s) of non-transitory computer-readable storage medium, for example a hard disk drive, a compact disc, a digital video disc, or a tape drive. The storage unit 11 stores computerized codes of the function modules of the system 20.

The control unit 12 can be a processor, an application-specific integrated circuit (ASIC), or a field programmable gate array (FPGA), for example. The control unit 12 can execute the computerized codes of the function modules of the computing device 10 to carry out the functions of the system 20.

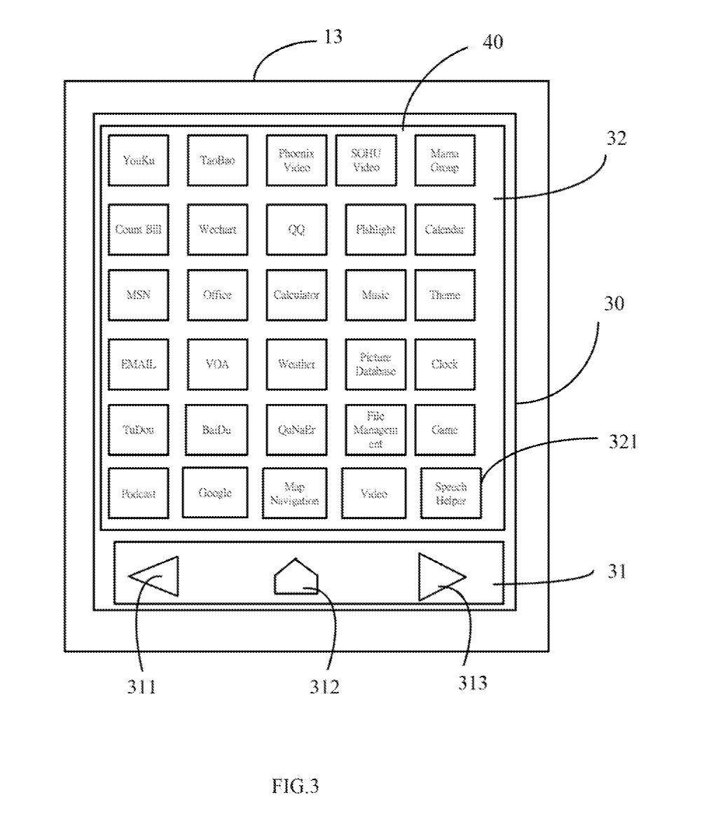

The touch screen 13 can display a number of icons. Each of the icons is associated with an application installed in the computing device 10. As shown in FIG. 3, the touch screen 13 can include a display interface 30. In the embodiment, the display interface 30 includes a first display area 31 and a second display area 32. A number of functional icons are displayed on the first display area 31, for example a backward button icon 311, a home button icon 312, and a forward button icon 313. Each of functional icons can be depressed or can be touched to control the computing device 10 to perform a function. For example, when the backward button icon 311 is depressed or touched, the contents displayed on the touch screen 13 are changed so as to return to a previous page. A number of application icons 321 are displayed on the second display area 32. When the number of the applications installed on the computing device 10 increases, so all the icons cannot be displayed on one page of the second display area 32 of the display interface 30, then the icons associated with these applications can be displayed on multiple pages of the second display area 32, and an initial desktop interface including multiple pages is formed.

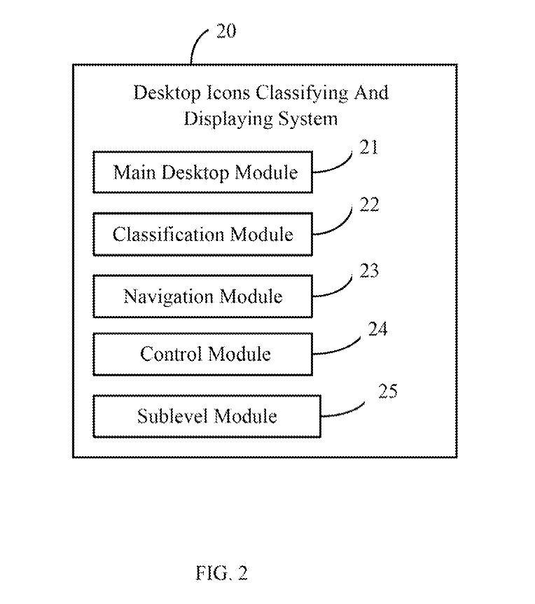

FIG. 2 is a block diagram of one embodiment of the function modules of the system 20. In at least one embodiment, the function modules can include a main desktop module 21, a classification module 22, a navigation module 23, a control module 24, and a sublevel module 25. The function modules 21-25 can include computerized codes in the form of one or more programs, which are stored in the storage unit 11. The control unit 12 executes the computerized codes to provide functions of the function modules 21-25.

The main desktop module 21 can generate a main interface 40 according to the number of applications installed on the computing device 10. The main interface 40 includes icons associated with the applications. In the embodiment, the area of the main interface 40 is the area of the second display area 32.

In one embodiment, when the number of the applications installed on the computing device 10 is larger than a predefined number, the main desktop module 21 miniaturizes the icons of the applications to generate the main interface 40. The main interface 40 as shown in FIG. 3 is populated by miniaturized icons of the applications. In an alternative embodiment, when the number of the applications installed on the computing device 10 is smaller than a predefined number, the main desktop module 21 magnifies the icons of the applications to generate the main interface. When every icon displayed on the second display area 32 has a same predefined size, the predefined number equals the number of the icons that can be wholly fitted within the second display area 32 with the predefined size. A sliding operation can zoom in or zoom out the main interface 40.

The classification module 22 can obtain classes of the applications associated with icons of the main interface. In the embodiment, the classification module 22 obtain classed of the applications according to functions of the applications. In an alternative embodiment, the classification module 22 further counts the number of the applications that belong to a single class.

The navigation module 23 can generate a navigation interface according to the classes obtained by the classification module 22.

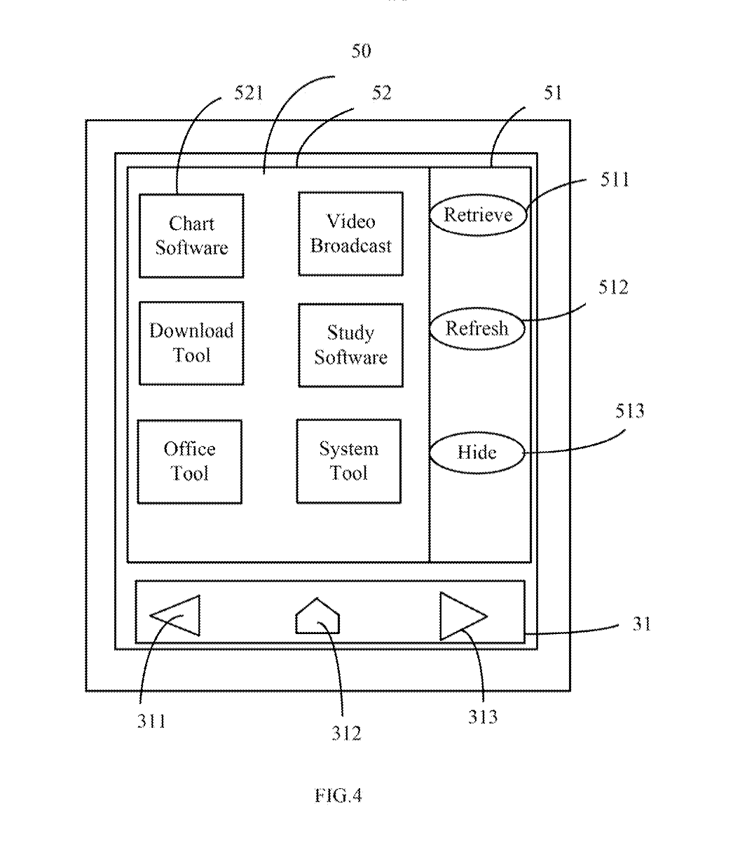

FIG. 4 shows a diagrammatic view of an embodiment of a navigation interface 50. The navigation interface 50 is displayed on the second display area 32. The navigation interface 50 includes a first navigation interface 51 and a second navigation interface 52. A number of functional icons are displayed on the first navigation interface 51, for example a retrieve icon 511, a refresh icon 512, and a hide icon 513. When the functional icons of the first navigation interface 51 are depressed or touched, the control module 24 controls the navigation interface 50 to perform functions associated with the functional icons. For example, when the retrieve icon 511 is depressed, a search box is displayed on the navigation interface 50 for users to input information for searching applications. When the refresh icon 512 is depressed, the displayed navigation interface 50 is updated. When the hide icon 513 is depressed; the control module 24 hides the navigation interface 50. A number of class icons 521 are displayed on the second navigation interface 52. Each of class icons 521 is associated with one class of applications. In one embodiment, the location of each of the class icons 512 displayed on the second navigation interface 52 is relative to the number of the applications belonging to that class, for example, when the number of the applications belonging to a class is the largest number, the class icon is listed first or before the others.

The control module 24 can recognize a request to search for applications which belong to a single class. In the embodiment, the control module 24 recognizes a touch operation applied on one of the class icons 521 on the navigation interface 50. When a touch operation is applied to a particular class icon 521, the control module 24 determines that a request is made to search for all the applications of that class.

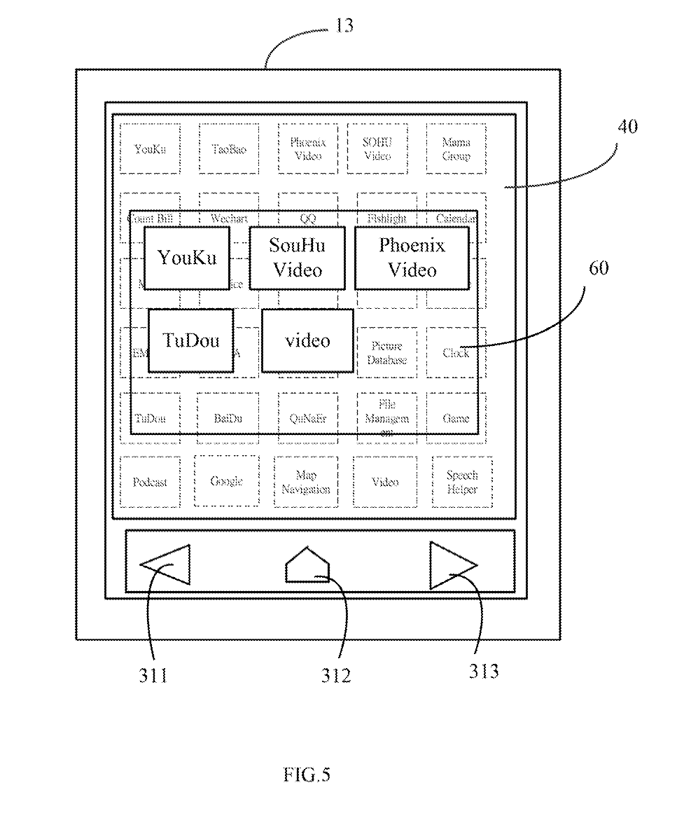

Also referring to FIG. 5, the sublevel module 25 can generate a sub-interface 60 in response to the request recognized by the control module 24. In the embodiment, the sub-interface 60 includes icons of all applications which belong to a same class, and is displayed in the second display area 32. The control module 24 can open the applications associated with the icons in the sub-interface 60 in response to operations applied on the icons of the sub-interface 60. The control module 24 can perform a function associated with the functional icon in response to operations on the first display area 31. For example, when the backward icon 311 is touched or depressed, the control module 24 closes the sub-interface 60 and then displays the navigation interface 50 in the second display area 32; thus, a user can search for applications of another class in the navigation interface 50. When the home icon 312 is touched or depressed, the control module 24 closes the sub-interface 60, and then displays the main interface 40 in the second display area 32.

The control module 24 can simultaneously display the main interface 40 and the sub-interfaces 60 on the touch screen 13.

In the embodiment, the control module 24 can dimly display the main interface 40 and highlighting the display of the sub-interface 60 which is displayed above the main interface 40, as FIG. 5 demonstrates.

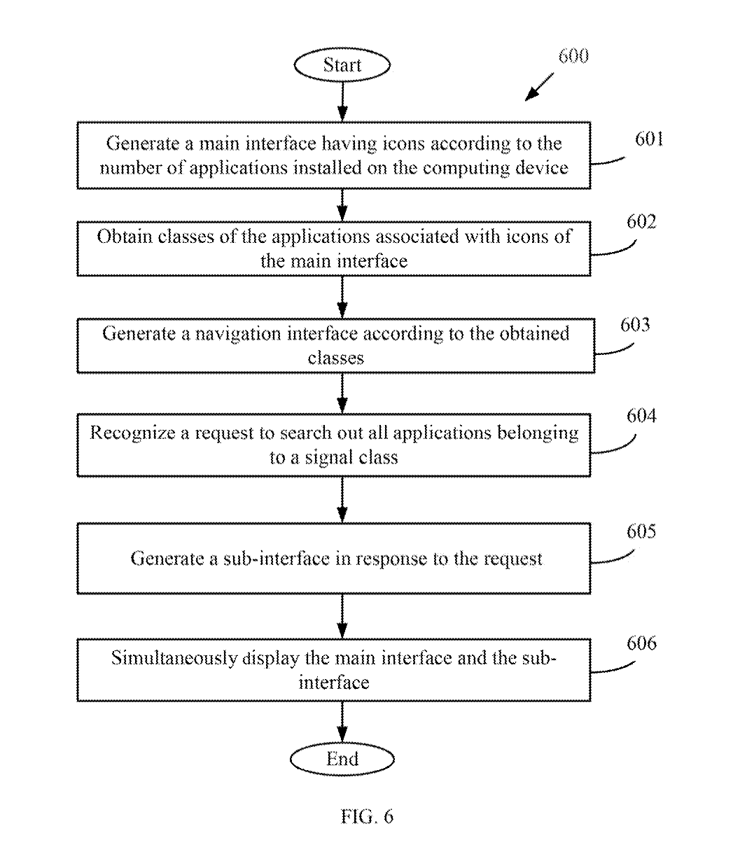

Referring to FIG. 6, a flowchart is presented in accordance with an example embodiment illustrated. The example method 600 is provided by way of example, as there are a variety of ways to carry out the method. The method 600 described below can be carried out using the configurations illustrated in FIGS. 1-5, for example, and various elements of these figures are referenced in explaining example method 600. Each block shown in FIG. 6 represents one or more processes, methods or subroutines, carried out in the exemplary method 600. Additionally, the illustrated order of blocks is by example only and the order of the blocks can change. The exemplary method 600 can begin at block 601. Depending on the embodiment, additional steps can be added, others removed, and the ordering of the steps can be changed.

At block 601, the main desktop module generates a main interface having icons according to the number of applications installed on the computing device. Each of the icons is associated with an application.

At block 602, the classification module obtains classes of the applications associated with icons of the main interface.

At block 603, the navigation module generates a navigation interface according to the classes obtained by the classification module.

At block 604, the control module recognizes a request to search out all the applications belonging to a single class.

At block 605, the sublevel module generates a sub-interface in response to the request recognized by the control module. The sub-interface presents all the icons of applications belonging to the single class.

At block 606, the control module simultaneously displays the main interface and the sub-interfaces.

The embodiments shown and described above are only examples. Many details are often found in the art and many such details are therefore neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for classifying and displaying icons on a desktop executable by at least one processor of a computing device, the method comprising:
generating a main interface having a plurality of icons, wherein each icon is associated with an application installed on the computing device;
obtaining classes of the applications associated with icons of the main interface based on functions of the applications;
generating a navigation interface having a plurality of class icons according to the obtained classes of the applications, wherein each of the class icons represents one class of the applications;
recognizing a request to search for all applications within a class based an operation applied on one of the plurality of the class icons of the navigation interface, wherein the searched applications belong to a single class represented by the class icon; and
generating a sub-interface having all icons of the searched applications in response to the request.

2. The method according to claim 1, wherein the main interface and the sub-interface are simultaneously displayed.

3. The method according to claim 2, wherein the sub-interface is displayed above the main interface; and the main interface is dimly displayed and the sub-interface is displayed with highlighting displayed.

4. The method according to claim 1, wherein the main interface is generated according to quantity of the applications.

5. The method according to claim 4, wherein the main interface is generated by:
miniaturizing the icons of the applications when the quantity of the plurality of the applications is larger than a predefined number.

6. The method according to claim 4, wherein the main interface is generated by:
magnifying the icons of the applications when the quantity of the application is smaller than a predefined number.

7. The method according to claim 6, wherein the predefined number equals quantity of the icons which can be wholly fitted within a display area with a same predefined size.

8. A computing device, comprising:
a touch screen;
a control unit; and
a storage unit storing one or more programs which, when executed by the control unit, causes the control unit to:
generate a main interface having a plurality of icons, wherein each icon is associated with an application installed on the computing device;
obtain classes of the applications associated with icons of the main interface based on functions of the applications;
generate a navigation interface having a plurality of class icons according to the obtained classes of the applications, wherein each of the class icons associates with one class of the applications;
recognize a request to search for all applications within a class based an operation on one of the plurality of the class icons of the navigation interface, wherein the searched applications belong to a single class represented by the class icon; and
generate a sub-interface having all icons of the searched applications in response to the request.

9. The computing device according to claim 8, wherein the applications are operated to be run in responses to operations applied on the icons of the sub-interface.

10. The computing device according to claim 9, wherein the request is recognized to search for applications which belong to a single class when a touch operation is applied on one class icon on the navigation interface.

11. The computing device according to claim 8, wherein the main interface and the sub-interface are simultaneously displayed.

12. The computing device according to claim 11, wherein the sub-interface is displayed above the main interface; and the main interface is dimly displayed and the sub-interface is highlighting displayed.

13. The computing device according to claim 12, wherein the main interface is generated according to quantity of the applications.

14. A non-transitory storage medium having stored thereon instructions that, when executed by a processor of an electronic device, causes the processor to perform a method for classifying and displaying icons, wherein the method comprises:
generating a main interface having a plurality of icons, wherein each icon is associated with an application installed on the computing device;
obtaining classes of the applications associated with icons of the main interface based on functions of the applications;
generating a navigation interface having a plurality of class icons according to the obtained classes of the applications, wherein each of the class icons represents one class of the applications;
recognizing a request to search for all applications within a class based an operation applied on a corresponding class icon of the navigation interface, wherein the searched applications belong to a single class represented by the class icon; and
generating a sub-interface having all icons of the searched applications in response to the request command.

15. The non-transitory storage medium according to claim 14, wherein the main interface and the sub-interface are simultaneously displayed.

16. The non-transitory storage medium according to claim 15, wherein the sub-interface is displayed above the main interface; and the main interface is dimly displayed and the sub-interface is highlighting displayed.

17. The non-transitory storage medium according to claim 16, wherein the main interface is generated by:
miniaturizing the icons of the applications when quantity of the application is larger than a predefined number.

18. The non-transitory storage medium according to claim 16, wherein the main interface is generated by:
magnifying the icons of the applications when quantity of the application is smaller than a predefined number.

19. The non-transitory storage medium according to claim 18, wherein the predefined number equals quantity of the icons which can be wholly fitted within a display area with a same predefined size.
